(19) United States
(12) Patent Application Publication
(10) Pub. No.: US 2020/0273431 A1
(43) Pub. Date: Aug. 27, 2020

(54) DISPLAY CONTROL DEVICE AND METHOD, AND DISPLAY SYSTEM

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Xue DONG, Beijing (CN); Hao ZHANG, Beijing (CN); Lingyun SHI, Beijing (CN); Wei SUN, Beijing (CN); Yafei LI, Beijing (CN); Tiankuo SHI, Beijing (CN); Zijiao XUE, Beijing (CN); Bo GAO, Beijing (CN); Xiurong WANG, Beijing (CN)

(21) Appl. No.: 16/063,341

(22) PCT Filed: Dec. 12, 2017
(86) PCT No.: PCT/CN2017/115522

§ 371 Date: Jun. 18, 2018

(30) Foreign Application Priority Data
May 12, 2017 (CN) 201710334097.3

(51) Int. Cl. G09G 5/37; G06F 3/01

(52) U.S. Cl. CPC G09G 5/37; G09G 2354/00; G06F 3/013

(57) ABSTRACT

A display control device for use with a display device. The display control device includes: an image pre-processor configured to divide an original image into a target area, a first non-target area, and a second non-target area, the image pre-processor being further configured to perform pre-processing on the original image, the pre-processing including reducing of a resolution of the first non-target area and the second non-target area; and a communication interface configured to transmit the pre-processed original image to the display device for display.

### CROSS REFERNCE TO RELATED APPLICATIONS

This application is the U.S national phase entry of PCT/CN2017/115522, with an international filing date of Dec. 12, 2017, which claims the benefit of Chinese Patent Application No. 201710334097.3 filed on May 12, 2017, the entire disclosures of which are incorporated herein by reference.

### TECHNICAL FIELD

The present disclosure relates to the field of display technology, and particularly to a display control device, a display control method, and a display system.

### BACKGROUND

High resolution display devices have become popular in the market. The images supplied to such a display device have such a high resolution that it takes a relatively long time for them to be transmitted from a signal source to the display device with the transmission speed being constant. This may affect a user's viewing experience.

### SUMMARY

It would be advantageous to provide a mechanism that may alleviate, mitigate or eliminate the above-mentioned problem.

According to an aspect of the present disclosure, a display control device for use with a display device is provided. The display control device comprises: an image pre-processor configured to divide an original image into a target area, a first non-target area, and a second non-target area, the first non-target area being aligned with the target area in a row direction of the original image, the second non-target area being an area other than the target area and the first non-target area, the image pre-processor further configured to perform pre-processing on the original image, the pre-processing comprising reducing of a resolution of the first non-target area and the second non-target area; and a communication interface configured to transmit the pre-processed original image to the display device for display.

In certain exemplary embodiments, the display control device further comprises a gaze tracker configured to identify a gaze region in a screen of the display device and provide an identification result to the image pre-processor. The image pre-processor is further configured to receive the identification result and perform the division of the original image based on the received identification result. The target area corresponds to the gaze region.

In certain exemplary embodiments, the display device comprises a pixel array arranged in a pattern for sub-pixel rendering, and the display control device further comprises an image renderer configured to perform the sub-pixel rendering on at least the target area such that the sub-pixel rendered target area can be displayed at the gaze region with an apparent resolution higher than a physical resolution of the display device.

According to another aspect of the present disclosure, a display system is provided comprising: a display device; and the display control device as recited above.

In certain exemplary embodiments, the display device comprises an image processor configured to perform post-processing on the pre-processed original image. The post-processing comprises increasing of the resolution of the first non-target area and the second non-target area to adapt to a physical resolution of the display device.

In certain exemplary embodiments, the post-processing further comprises resizing of at least one of the first non-target area or the second non-target area such that a size of the post-processed original image is adapted to a size of a screen of the display device.

In certain exemplary embodiments, the display device further comprises a pixel array arranged in a pattern for sub-pixel rendering, and the post-processing further comprises the sub-pixel rendering of at least the target area such that the sub-pixel rendered target area can be displayed at the gaze region with an apparent resolution higher than the physical resolution of the display device.

According to yet another aspect of the present disclosure, a display control method for a display device is provided. The method comprises: dividing an original image into a target area, a first non-target area, and a second non-target area, the first non-target area being aligned with the target area in a row direction of the original image, the second non-target area being an area other than the target area and the first non-target area; pre-processing the original image, the pre-processing comprising reducing a resolution of the first non-target area and the second non-target area; and transmitting the pre-processed original image to the display device for display.

According to still yet another aspect of the present disclosure, a display control device for use with a display device is provided. The display control device comprises: means for dividing an original image into a target area, a first non-target area, and a second non-target area, the first non-target area being aligned with the target area in a row direction of the original image, the second non-target area being an area other than the target area and the first non-target area; means for pre-processing the original image, the pre-processing comprising reducing a resolution of the first non-target area and the second non-target area; and means for transmitting the pre-processed original image to the display device for display.

These and other aspects of the present disclosure will be apparent from and elucidated with reference to the embodiment(s) described hereinafter.

### BRIEF DESCRIPTION OF THE DRAWINGS

The drawings are provided for a better understanding of the present disclosure and form a part of the specification. In the drawings:

FIG. 1 is a schematic block diagram of a display system including a display device and a display control device according to an embodiment of the present disclosure;

FIG. 2 is a schematic diagram of a screen of a display device having an identified gaze region;

FIG. 3 is a schematic diagram of an original image provided by a signal source to the display control device;

FIG. 4 is a schematic block diagram of the display device shown in FIG. 1;

FIG. 5 is a flowchart of a display control method according to an embodiment of the present disclosure; and

FIG. 6 is a block diagram of an example computing device that represents the display control device that may implement various techniques described herein.

### DETAILED DESCRIPTION

Embodiments of the present disclosure will be described in detail below with reference to the accompanying drawings.

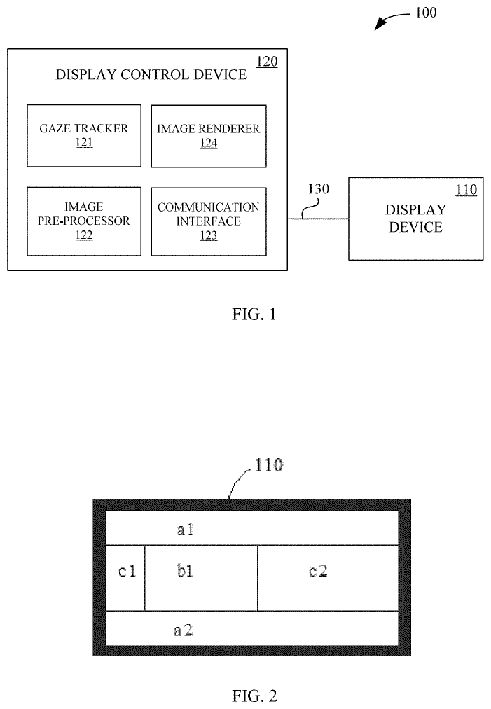

FIG. 1 is a schematic block diagram of a display system 100 according to an embodiment of the present disclosure. As shown in FIG. 1, the display system 100 includes a display device 110 and a display control device 120, both of which are connected through a communication medium 130, such as an HDMI cable. Examples of the display device 110 include, but are not limited to, a television, a monitor, or a head mounted display (e.g., in an application scenario of virtual reality (VR)). The display control device 120 is generally positioned at a signal source (not shown) that supplies the display device 110 with video/image data. Depending on the specific application scenario, the signal source may take the form of, e.g., a DVD player, a game console, a personal computer host, or the like. The display control device 120 includes a gaze tracker 121, an image pre-processor 122, and a communication interface 123.

The gaze tracker 121 is configured to identify a gaze region in a screen of the display device 110, i.e., a region in the screen that is gazed by the user. Any known or future gaze tracking techniques may be used in the gaze tracker 121. The gaze tracker 121 may generally include a camera that captures the user's eye movements and other hardware and software resources that calculate the user's gaze region from the data captured by the camera. Although the gaze tracker 121 is shown in FIG. 1 as an integral part of display control device 120, this is not necessary. In one implementation, the gaze tracker 121 may be formed as an accessory of the display device 110 or a separate device and positioned at or near the display device 110 in order to monitor the user's gaze. In another implementation, the camera and other hardware and software resources of the gaze tracker 121 may be distributed separately from one another. For example, the camera may be located at or near the display device 110, and other hardware and software resources may be included in the display control device 120 that is separate from the display device 110. The gaze tracker 121 can deliver the identification of the gaze region in the screen of the display device 110 to the image pre-processor 122 via any suitable communication medium. In embodiments where the gaze tracker 121 is positioned at or near the display device 110, the gaze tracker 121 may convey the identification of the gaze region in the screen of the display device 110 to the image pre-processor 122, for example, via the communication medium 130 shown in FIG. 1.

With reference to FIG. 2, the screen of the display device 110 is schematically shown that has an identified gaze region b1. The gaze region b1 is shown in the example of FIG. 2 as being located in the center of the screen, surrounded by a non-gaze region including sub-regions a1, c2, a2, and c1. The present disclosure is however not limited thereto. For example, the gaze region b1 may be located anywhere in the screen.

Referring back to FIG. 1, the image pre-processor 122 is configured to, based on the identification of the gaze region, divide an original image from the signal source (not shown) into a target area corresponding to the gaze region, a first non-target area aligned with the target area in a row direction of the original image, and a second non-target area other than the target area and the first non-target area. The image pre-processor 122 is also configured to pre-process the original image, for example, to reduce the resolution of the non-target area. The reduction in the resolution can be achieved by, for example, down-sampling. An image with a non-target area having a reduced resolution can be transmitted more quickly from the signal source to the display device 110, especially taking into account the fact that the non-target area occupies a larger proportion of the image with respect to the target area corresponding to the gaze region. Moreover, since the non-target area portion of the image corresponds to the region in the screen of the display device 110 that is not gazed by the user, the reduction in the resolution of the non-target area does not result in a reduction in the user's viewing experience.

With reference to FIG. 3, an original image is schematically shown that is provided by the signal source to the display control device 120. The image is now divided by the image pre-processor 122 shown in FIG. 1 into a target area B1 corresponding to the gaze region b1 shown in FIG. 2, first non-target areas C1, C2 corresponding to the non-gaze sub-regions c1, c2, and second non-target areas A1, A2 corresponding to the non-gaze sub-regions a1, a2. The first non-target areas C1, C2 are aligned with the target area B1 in the row direction of the original image. The second non-target areas A1, A2 are an area of the image other than the target area B1 and the first non-target areas C1, C2, which in the example of FIG. 3 include a sub-area A1 located at the upper part of the image and a sub-area A2 located at the lower part of the image. As described above, the resolution of the first non-target areas C1, C2 and the second non-target areas A1, A2 may be reduced in order to speed up the transmission from the signal source to the display device. The division of the original image may be advantageous since it allows different processing of different areas at the display device for desired purposes. For example, the second non-target areas A1 and A2 may be displayed using a so-called Smart View technique in which a plurality of rows of pixels are simultaneously selected and supplied with image data. This can reduce the frequency at which the driving circuit of the display device operates, thereby saving power consumption. The target area B1 and the first non-target areas C1, C2 may be displayed differently from the second non-target area A1, A2 accounting for the physical properties of the display device and the desired resolution, as will be described below.

Referring back to FIG. 1, the communication interface 123 is configured to transmit the pre-processed original image to the display device 110 for display. The display control device 120 may optionally include an image renderer 124. The image renderer 124 is configured to perform sub-pixel rendering (SPR) on the target area and optionally the first non-target area and the second non-target area of the original image. As is known, SPR is a technique for improving the apparent resolution of a display by rendering pixels to take into account the physical properties of the screen type. The SPR technique may be applied to a display device including a pixel array arranged in a pattern for SPR so as to display the rendered image with an apparent resolution higher than the physical resolution of the display device. One example of such a pixel array is a so-called delta pixel arrangement, which can be found in Chinese Patent Publication No. CN 103886825 A incorporated herein by reference. Specifically, the delta pixel arrangement includes a plurality of sub-pixels arranged in an array, wherein every two adjacent rows of the sub-pixels are staggered with respect to each other by half a width of the sub-pixel, and each of the sub-pixels has a different color from that of its two directly adjacent sub-pixels in a directly adjacent row. An SPR algorithm applicable to such a delta pixel arrangement can also be found in this Chinese patent publication, which therefore will not be described in detail herein. Other SPR algorithms are possible in other embodiments. The presence of the image renderer 124 may be advantageous for improving the user's viewing experience in that the image (area) after being sub-pixel rendered may be displayed with a higher apparent resolution on the display device 110.

In the above embodiments, the image pre-processor 122, the communication interface 123, and the image renderer 124 may each be implemented in hardware, software, firmware, or any combination thereof. For example, combinational logic may be used to implement the functions of the image pre-processor 122, the communication interface 123, and/or the image renderer 124.

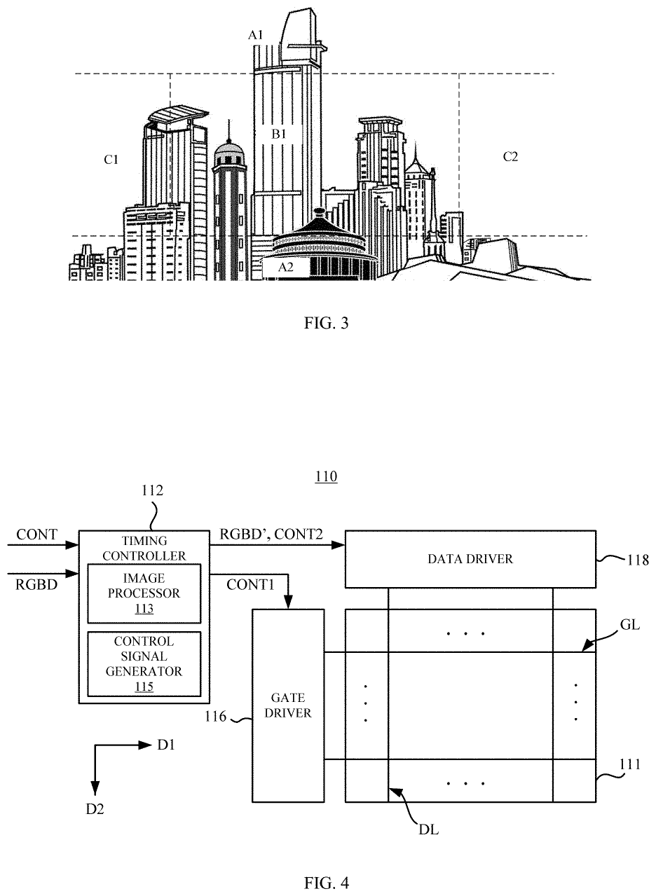

FIG. 4 is a schematic block diagram of the display device 110 shown in FIG. 1. Referring to FIG. 4, the display device 110 includes a display panel 111, a timing controller 112, a gate driver 116, and a data driver 118.

The display panel 111 is connected to a plurality of gate lines GL and a plurality of data lines DL. The display panel 111 displays an image having a plurality of grayscales based on output image data RGBD′. The gate lines GL may extend in a first direction D1, and the data lines DL may extend in a second direction D2 intersecting (e.g., substantially perpendicular to) the first direction D1. The display panel 100 may include a plurality of pixels (not shown) arranged in a matrix. The plurality of pixels may be arranged in a pattern for sub-pixel rendering as described above.

The timing controller 112 controls the operations of the display panel 111, the gate driver 116, and the data driver 118. In the example of FIG. 4, the timing controller 112 includes an image processor 113 and a control signal generator 115, although the image processor 113 may be a standalone component. The image processor 113 may receive input image data RGBD from an external device (for example, the display control device 120 shown in FIG. 1), and may perform any appropriate processing on the input image data RGBD to generate the output image data RGBD′. For example, the image processor 113 may increase the resolution of the first non-target area and the second non-target area in the original image to adapt the physical resolution of the display device. This can be achieved by, for example, up-sampling. For another example, the image processor 113 may resize at least one of the first non-target area or the second non-target area such that the size of the processed original image is adapted to the size of the screen of the display device. The resizing may, for example, include cropping and/or padding of an image. This allows a peripheral area of an up-sampled image to be cropped if the image has a larger size than the screen of the display device and to be added with a blank space if the up-sampled image has a smaller size than the screen of the display device. Where the display panel 111 includes a pixel array arranged in a pattern for sub-pixel rendering as described above, the image renderer 124 in the display control device 120 shown in FIG. 1 may alternatively reside in the image processor 113 of the display device 110. In other words, the image processor 113 may further perform sub-pixel rendering on the target area and optionally the first non-target area and the second non-target area in the original image. The control signal generator 115 may receive input control signals CONT from the display control device 120 shown in FIG. 1, and may generate a first control signal CONT1 for the gate driver 116 and a second control signal CONT2 for the data driver 118 based on the input control signals CONT. The control signal generator 115 may output the first control signal CONT1 to the gate driver 116, and may output the second control signal CONT2 to the data driver 118. The first control signal CONT1 may include a vertical start signal, a gate clock signal, and the like. The second control signal CONT2 may include a horizontal start signal, a data clock signal, a data load signal, a polarity control signal, and the like.

The gate driver 116 receives the first control signal CONT1 from the timing controller 112. The gate driver 116 generates a plurality of gate signals for driving the gate lines GL based on the first control signal CONT1. The gate driver 116 may sequentially apply the plurality of gate signals to the gate lines GL.

The data driver 118 receives the second control signal CONT2 and the output image data RGBD′ from the timing controller 112. The data driver 118 generates a plurality of data voltages based on the second control signal CONT2 and the output image data RGBD′. The data driver 118 may apply the plurality of data voltages to the data lines DL.

It will be understood that the configuration of the display device 110 shown and described above is exemplary and that other embodiments are possible.

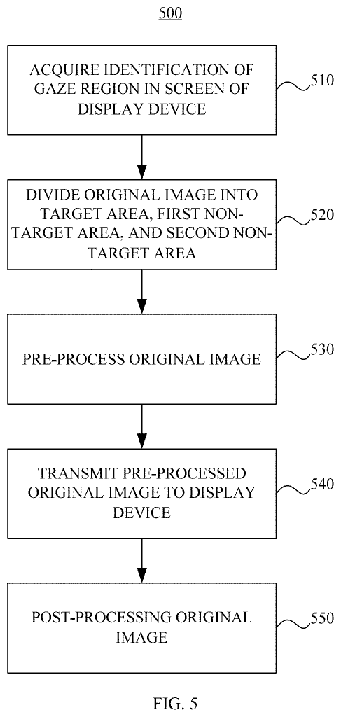

FIG. 5 is a flowchart of a display control method 500 according to an embodiment of the present disclosure.

At step 510, an identification of a gaze region in a screen of the display device is acquired. This can be achieved using the gaze tracker 121 as shown in FIG. 1. Step 510 may be optional. At step 520, an original image supplied by a signal source is divided, based on the identification of the gaze region in the screen of the display device, into a target area corresponding to the gaze region, a first non-target area aligned with the target area in a row direction of the original image, and a second non-target area other than the target area and the first non-target area. At step 530, the non-target area is pre-processed. The pre-processing may include reducing the resolution of the first non-target area and the second non-target area. Steps 520 and 530 may be implemented using the image pre-processor 122 as shown in FIG. 1. In some embodiments, the method 500 may further include performing sub-pixel rendering on the original image, in particular on the target area. This may be achieved using the image renderer 124 described above with respect to FIG. 1. At step 540, the pre-processed (and potentially sub-pixel rendered) original image is transmitted to the display device for display. Step 540 may be achieved using the communication interface 123 as shown in FIG. 1. At step 550, the original image is post-processed. The post-processing may include increasing the resolution of the first non-target area and the second non-target area in the original image. Additionally, the post-processing may also include re-sizing at least one of the first non-target area or the second non-target area. In some embodiments, the post-processing may also include performing sub-pixel rendering on at least the target area. Step 550 may be achieved at the display device 110 described above with respect to FIG. 4.

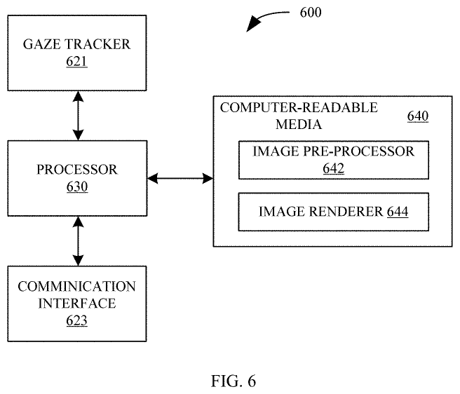

FIG. 6 is a block diagram of an example computing device 600 representing the display control device that may implement the various techniques described herein. The display control device 120 shown in FIG. 1 may take the form of the computing device 600. As shown in FIG. 6, the computing device 600 includes a gaze tracker 621, a communication interface 623, a processor 630, and one or more computer-readable media 640 in which an image pre-processor 642 and an image renderer 644 are stored in the form of software.

The gaze tracker 621 may be the gaze tracker 121 as shown in FIG. 1, which generally includes a camera that captures the user's eye movements and other hardware and software resources that calculate the user's gaze region from the data captured by the camera. The gaze tracker 621 is not necessarily an integral part of computing device 600. For example, it may operate as a standalone device or an accessory of a display device in some embodiments.

The processor 630 may execute computer-executable instructions stored in the one or more computer-readable media 640 to implement the functions of the image pre-processor 642, the image renderer 644, and optionally one or more other applications, routines, modules, drivers, etc. The processor 630 may be a microprocessor, a controller, or any other suitable type of processor for processing computer-executable instructions to control the operation of the computing device 600 to perform the techniques described herein. In some examples, e.g., where a system-on-chip architecture is used, the processor 630 may include one or more fixed function blocks (also referred to as accelerators) that implement part of the techniques as described herein in hardware (instead of software or firmware). Alternatively or additionally, the functionality described herein may be performed at least in part by one or more hardware logic components. By way of example, and not limitation, illustrative types of hardware logic components that may be used include field programmable gate arrays (FPGAs), application-specific integrated circuits (ASICs), program-specific standard products (ASSPs), system-on-chips (SOCs), and complex programmable logical devices (CPLDs). In some embodiments, the functionality of the processor 630, the image pre-processor 642, and the image renderer 644 may optionally be distributed over two or more devices (e.g., the signal source and the display device), which may be located at remote locations and/or configured for collaborative processing. For example, the processing and storage resources for implementing the image renderer 644 may be included in a display device separate from the computing device 600.

The one or more computer-readable media 640 store computer-executable instructions therein. The computer-readable media 640 may include computer storage media such as, for example, memories and communication media. Computer storage media, such as a memory, include volatile and nonvolatile, removable and non-removable media, implemented in any method or technology for storing information such as computer readable instructions, data structures, program modules, or other data. Computer storage media include, but are not limited to, RAM, ROM, EPROM, EEPROM, flash memory or other memory technologies, CD-ROM, digital versatile disc (DVD) or other optical storage devices, cartridges, magnetic tapes, disk storage devices, or other magnetic storage device, or any other non-transport medium that can be used to store information for access by a computing device. In contrast, communication media may embody computer readable instructions, data structures, program modules, or other data in a modulated data signal such as a carrier wave or other transport mechanism. As defined herein, computer storage media does not include communication media. Therefore, computer storage media should not be interpreted as a propagated signal per se. The propagated signal may be present in a computer storage medium, but the propagated signal itself is not an example of a computer storage medium. Although the computer-readable medium 640 is shown within the computing device 600, it will be appreciated that it can be distributed or remotely located and can be accessed via a network or other communication link (e.g., using the communication interface 623).

The communication interface 623 may be arranged to transmit data to or receive data from a display device and may include a wireless or wired transmitter and/or receiver. As a non-limiting example, the communication interface 623 may be configured to communicate via an HDMI cable, a wireless local area network, a wired local area network, or the like.

The term “computer” or “computing device” is used herein to refer to any device that has processing capabilities such that it can execute instructions. Those skilled in the art will recognize that such processing capabilities are incorporated into many different devices, and thus the terms “computer” and “computing device” each include a PC, a server, a mobile phone (including a smartphone), a tablet computer, a set-top box, a media player, a game console, a personal digital assistant, and many other devices.

The methods described herein may be performed by software in a machine-readable form (e.g., a computer program including computer program code means that is adapted to, when the program is run on a computer and where the computer program can be embodied on a computer readable medium, perform all steps of any of the methods described herein) on a tangible storage medium. The software may be suitable for execution on a parallel processor or serial processor such that the method steps may be performed in any suitable order or simultaneously.

It can be understood that the foregoing is merely exemplary embodiments for purposes of illustrating the principle of the present disclosure, and that the present disclosure is not limited thereto. For a person of ordinary skill in the art, various variations and improvements may be made without departing from the spirit and essence of the present disclosure. These variations and improvements are also considered to be within the protection scope of the present disclosure.

1. A display control device for use with a display device, comprising:
an image pre-processor configured to divide an original image into a target area, a first non-target area, and a second non-target area, the first non-target area being aligned with the target area in a row direction of the original image, the second non-target area being an area other than the target area and the first non-target area, the image pre-processor being further configured to perform pre-processing on the original image, the pre-processing comprising reducing of a resolution of the first non-target area and the second non-target area; and
a communication interface configured to transmit the pre-processed original image to the display device for display.

2. The display control device of claim 1, further comprising a gaze tracker configured to identify a gaze region in a screen of the display device and to provide an identification result to the image pre-processor, wherein the image pre-processor is further configured to receive the identification result and perform the division of the original image based on the received identification result, wherein the target area corresponds to the gaze region.

3. The display control device of claim 2, wherein the display device comprises a pixel array arranged in a pattern for sub-pixel rendering, the display control device further comprising an image renderer configured to perform the sub-pixel rendering on at least the target area such that the sub-pixel rendered target area is displayed at the gaze region with an apparent resolution higher than a physical resolution of the display device.

4. A display system comprising:
a display device; and
the display control device as recited in claim 1.

5. The system of claim 4, further comprising a gaze tracker configured to identify a gaze region in a screen of the display device and to provide an identification result to the image pre-processor of the display control device, wherein the image pre-processor is further configured to receive the identification result and perform the division of the original image based on the received identification result, wherein the target area corresponds to the gaze region.

6. The system of claim 5, wherein the display device comprises an image processor configured to perform post-processing on the pre-processed original image, the post-processing comprising increasing of the resolution of the first non-target area and the second non-target area to adapt to a physical resolution of the display device.

7. The system of claim 6, wherein the post-processing further comprises resizing of at least one of the first non-target area or the second non-target area such that a size of the post-processed original image is adapted to a size of the screen of the display device.

8. The system of claim 6, wherein the display device further comprises a pixel array arranged in a pattern for sub-pixel rendering, and wherein the post-processing further comprises the sub-pixel rendering of at least the target area such that the sub-pixel rendered target area is displayed at the gaze region with an apparent resolution higher than the physical resolution of the display device.

9. A display control method for a display device, comprising:
dividing an original image into a target area, a first non-target area, and a second non-target area, the first non-target area being aligned with the target area in a row direction of the original image, the second non-target area being an area other than the target area and the first non-target area;
pre-processing the original image, the pre-processing comprising reducing a resolution of the first non-target area and the second non-target area; and
transmitting the pre-processed original image to the display device for display.

10. The method of claim 9, further comprising acquiring an identification of a gaze region in a screen of the display device and performing the dividing of the original image based on the identification such that the target area corresponds to the gaze region.

11. The method of claim 10, further comprising post-processing the pre-processed original image at the display device, the post-processing comprising increasing the resolution of the first non-target area and the second non-target area to adapt to a physical resolution of the display device.

12. The method of claim 11, wherein the post-processing further comprises resizing at least one of the first non-target area or the second non-target area such that a size of the post-processed original image is adapted to a size of the screen of the display device.

13. The method of claim 11, wherein the display device further comprises a pixel array arranged in a pattern for sub-pixel rendering, and wherein the post-processing further comprises performing the sub-pixel rendering on at least the target area such that the sub-pixel rendered target area is displayed at the gaze region with an apparent resolution higher than the physical resolution of the display device.

14. A display control device for use with a display device, comprising:
means for dividing an original image into a target area, a first non-target area, and a second non-target area, the first non-target area being aligned with the target area in a row direction of the original image, the second non-target area being an area other than the target area and the first non-target area;
means for pre-processing the original image, the pre-processing comprising reducing a resolution of the first non-target area and the second non-target area; and
means for transmitting the pre-processed original image to the display device for display.

15. The display control device of claim 14, further comprising means for identifying a gaze region in a screen of the display device, wherein the means for dividing is further for performing the dividing of the original image based on the identification of the gaze region such that the target area corresponds to the gaze region.

16. The display control device of claim 15, wherein the display device comprises a pixel array arranged in a pattern for sub-pixel rendering, the display control device further comprising means for performing the sub-pixel rendering on at least the target area such that the sub-pixel rendered target area is displayed at the gaze region with an apparent resolution higher than a physical resolution of the display device.
